(19) United States
(12) Patent Application Publication
(10) Pub. No.: US 2024/0426729 A1
(43) Pub. Date: Dec. 26, 2024

(54) System and Method for Determining Particulate Size Distribution and Other Properties from a Combined Optical and Aerodynamic Inversion

(71) Applicant: AirPhoton, LLC, Baltimore, MD (US)

(72) Inventor: Jose Vanderlei Martins, Greenbelt, MD (US)

(21) Appl. No.: 18/827,941

(22) Filed: Sep. 9, 2024

Related U.S. Application Data
(63) Continuation of application No. 17/189,016, filed on Mar. 1, 2021.
(60) Provisional application No. 62/983,745, filed on Mar. 1, 2020.

(51) Int. Cl. G01N 15/0205

(52) U.S. Cl. CPC G01N 15/0211

(57) ABSTRACT

A optical engine includes a body having a top surface, an opposing bottom surface, and a sampling chamber located between the top surface and the bottom surface. A plurality of light sources extends radially from the sampling chamber such that each of the plurality of light sources extends along its own longitudinal axis. A like plurality of light traps extends radially from the sampling chamber. Each of the like plurality of light traps is associated with one of the plurality of light sources across the sampling chamber and extends along the longitudinal axis of its associated light source. An optical detector extends radially from the sampling chamber along a photomultiplier longitudinal axis. A photomultiplier light trap is diametrically opposite from the optical detector across the sampling chamber along the photomultiplier longitudinal axis. The system can also be assembled in an inverse configuration where the detector and light sources exchange positions.

### CROSS REFERENCE TO RELATED APPLICATION

The present application claims priority from U.S. Provisional Patent Application Ser. No. 62/983,745, filed on Mar. 1, 2020, which is incorporated herein by reference in its entirety.

### BACKGROUND OF THE INVENTION

The present invention is in the technical field of measurements of particulate material properties based on a combination of aerodynamic size separation and optical scattering measurements. The retrieved information can be related to multiple properties of the particles including size, shape, composition, refractive index, density, mass, and other properties which can be derived using a numerical retrieval.

Aerodynamic separation devices provide a method to separate particulates from air, gas or a liquid stream via the motion of the particle within this fluid. Rotational effects, inertia and gravity are used to separate mixtures of solids and fluids without having to resort to the use of solid or liquid substrate filtration devices. Most common devices are cyclones and impactors. These devices have been used for decades to remove particles of all sizes from an air stream in industrial applications such as oil refineries and paper mills and the technique has also been applied to bagless vacuum cleaners. These devices are also used to facilitate sampling and collection of airborne particulates for immediate or retrospective analysis. For cyclones in particular, larger and heavier particles settle out of the fluid stream and are unable to pass through the device leaving only the smaller particles to emerge from the outlet. The cyclone geometry and the rate of the fluid movement through the cyclone determine the cut point which is the size of particle that will be removed from the stream with 50% efficiency. Sharp Cut Cyclone separators are a subset of cyclone separators which are designed to more strictly limit the number of particles above the desired size range which can pass through to the outlet. Sharp cyclone separators are frequently used in air quality sampling to collect all particulates below a single specific maximum size which are of interest to human health studies. Typically, in the air quality field, this size range is selected at 2.5 microns in diameter, referred to as PM 2.5. Other studies on air quality and visibility frequently collect all particles up to and including the size of 10 microns in diameter referred to as PM10. More recent studies have focused on the health effects of just the smallest particles of 1 micron size or less (PM 1).

One class of device commonly used to measure light scattering properties of particulate material are called nephelometers and are usually divided between integrating (measuring a broad range of angles integrated into a single signal) and polar (measuring multiple individual angles with a given angular resolution). These devices have also been used for decades to measure the multi-wavelength light scattering pattern produced by particulate material in suspension in air, water, or other fluids.

Numerical retrievals of particle properties from combinations of measurements of light scattering and other measured constraints have a long history, having been applied to both space-based remote sensing observations and in-situ polar nephelometer measurements. The goal of a retrieval is to constrain the range of possible combinations of particle properties by the physics of how particles with different properties scatter light spectrally, angularly and polarimetrically.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention covers the apparatus, method and software required to retrieve the desired information about particles in an airstream.

The apparatus uses an inlet with an aerodynamic separator (for instance a cyclone) collecting particles from an air stream for which the flow is dynamically measured and controlled to separate particulates with different maximum particle sizes before they are introduced into an instrument for analysis. The dynamic flow control assures that different particle sizes will be measured at distinct times.

The method relies on the apparatus to provide the aerodynamic separation of the particles to restrict the range of particle sizes (eg. Particles<1 um) that are subjected to optical measurements like angular scattering at multiple wavelengths, and/or multiple angles, and/or multiple polarizations.

The data from the scattering measurements are then analyzed by our software which applies a numerical retrieval (inversion) to derive the particle size distribution and/or other microphysical properties such as but not limited to shape and refractive indices.

In an exemplary embodiment, an optical engine includes a body having a top surface, an opposing bottom surface, and a sampling chamber located between the top surface and the bottom surface. A plurality of light sources extends radially from the sampling chamber such that each of the plurality of light sources extends along its own longitudinal axis. Each light source is mounted in a particular position corresponding to a distinctive scattering angle geometry. Each light source is turned on for the measurement of a particular scattering geometry and they are all multiplexed on and off in high speed, to cover the different angular geometries. The number of light sources can start at two and span a large number with different angles, fields of view, wavelengths, and polarization states. The particular geometry can vary according to the desired combination of scattering angles.

A like plurality of light traps extends radially from the sampling chamber, such that each of the like plurality of light traps is associated with one of the plurality of light sources across the sampling chamber and extends along the longitudinal axis of its associated light source. The detecting telescope is strategically positioned with a narrow field of view in order to minimize the range of scattering angles produced by the combination between light source and detector. An optical detector such as, but not limited to a photomultiplier tube, a solid state photomultiplier (SiPM), an avalanche photodiode, a photodiode, or a CCD array, extends radially from the sampling chamber along the detector longitudinal axis. A detector light trap is diametrically opposite from the detector across the sampling chamber along the detector longitudinal axis.

A second exemplary embodiment for the optical engine is an inverse system, where the light sources are replaced by detectors, and a single light source is placed in the location of the detector in the first embodiment. In this embodiment, the optical engine includes a sampling chamber located between the top and bottom surfaces. A plurality of light detectors extends along its own longitudinal axis. A like plurality of light traps extends radially from the sampling chamber, such that each of the like plurality of light traps is associated with one of the pluralities of light detectors across the sampling chamber and extends along the longitudinal axis of its associated detector. A light source, including but not limited to a laser system, LED illuminator, or incandescent light bulb, extends radially from the sampling chamber along the source longitudinal axis. A detector light trap is diametrically opposite from the light source across the sampling chamber along the source longitudinal axis.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a diagram of an exemplary embodiment of a measurement system according to the present invention.

FIG. 2 is a perspective view of an alternative exemplary embodiment of a measuring system according to the present invention.

FIG. 3A is an exemplary graph of discrete decreasing flow rate vs. time.

FIG. 3B is an exemplary graph of discrete increasing flow rate vs. time.

FIG. 3C is an exemplary graph of continuous decreasing signal vs. time.

FIG. 3D is an exemplary graph of continuous decreasing size and increasing flow vs. time.

FIG. 4 is an exemplary graph for periodic data acquisition, where the system is run continuously and steps through the different flow rates.

FIG. 5A is a diagram showing aerodynamic separation of a smaller size mode and how this corresponds to a input data set used to generate a resulting size distribution obtained from the inversion of a optical data set (multiwavelength, and/or multi-angular, and/or polarization)

FIG. 5B is the diagram of FIG. 5A, but moving the aerodynamic cutoff to a larger size range to allow for the inversion of the next size bin.

FIG. 5C is the diagram of FIG. 5B, but moving the aerodynamic cutoff to a larger size range to allow for the inversion of the next size bin.

FIG. 6 is a graph of size distribution of particles of different radii vs. volume per area of the particles.

FIG. 7 is a schematic drawing of an exemplary embodiment of a two-head system of the present invention.

FIG. 8 is a top plan view of a optical engine used with the apparatus of FIG. 1 to obtain particle data.

FIG. 9 is a side elevational view, in section, of the optical engine of FIG. 8, taken along lines 9-9 of FIG. 8.

FIG. 10 is a side elevational view, in section, of the optical engine of FIG. 8 taken along lines 10-10 of FIG. 8.

FIG. 11 is a side elevational view of two optical engines of FIG. 1, stacked on top of each other.

FIG. 12 is an alternative embodiment of an optical engine used with the apparatus of FIG. 1 to obtain particle data.

FIG. 13 is a schematic representation of the multi-source design of the engine of FIG. 12 showing a 4-state polarized source represented at a “single” scattering angle geometry with multiple sources placed across the whole semicircle of the scattering ring, covering multiple scattering angles simultaneously.

FIG. 14 is a schematic representation of the multi-detector design of the optical engine of FIG. 12, with only one set of the 4 detector's fiber optics collectors is indicated in the figure for simplicity of the diagram.

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

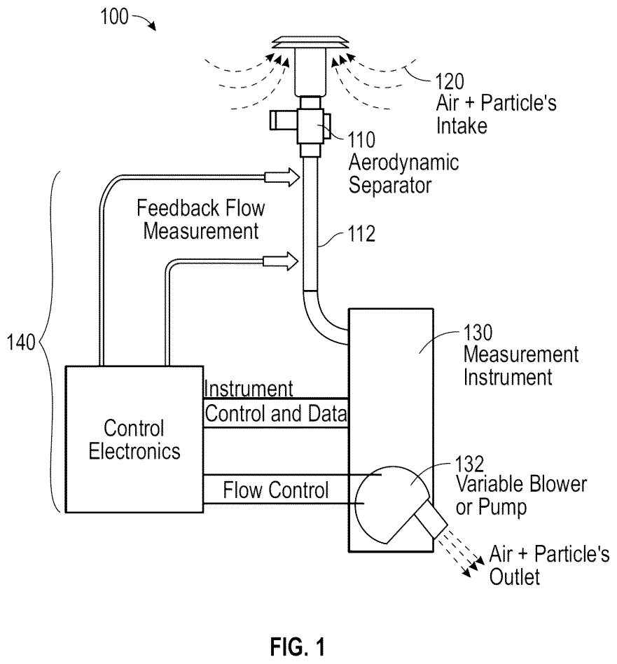

Referring now to the invention in more detail, shown in FIG. 1 is a schematic illustration of an angular scattering nephelometer assembly 100 according to an exemplary embodiment of the present invention. Assembly 100 includes an aerodynamic separator 110 with a modified inlet 120 attached to an analytical instrument, in this case a nephelometer 130. While nephelometer 130 is shown, there is no restriction for the analytical device to be a nephelometer or even an optical instrument of any kind. A nephelometer will be described for convenience throughout. The system and method proposed here can be used for multitude of analytical devices including (nephelometers, absorption meters, filter sampling devices, chemical speciation methods, mass measurement devices, etc.). Similarly, the aerodynamic separator 110 can be of different types including cyclones, impactors, elutriators, or other size separators that rely on flowrates for size selection. One exemplary concept behind the present invention is the synergy between the aerodynamic separator 110, the measurement device 130 and the variable blower or pump 132 in measurement device 130 with a control feedback system 140 that allow the selection of a particular particle cutoff size and its variation as function of time.

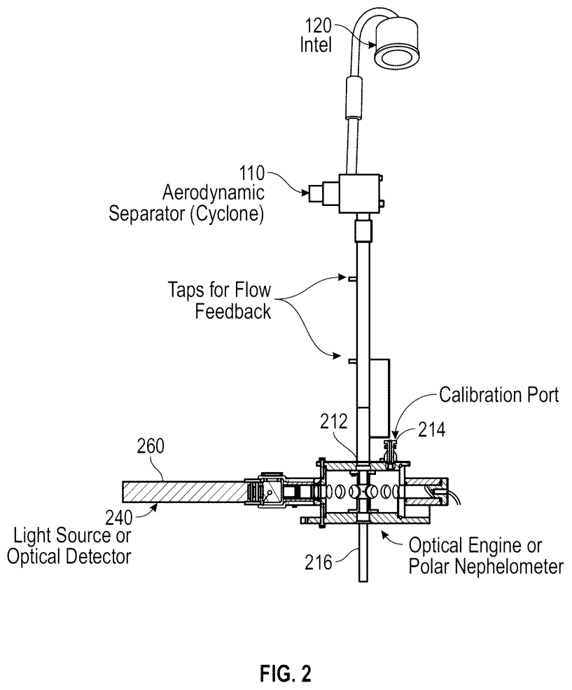

FIG. 2 shows an exemplary embodiment of assembly 100 developed to demonstrate the invention using a cyclone inlet 120, a nephelometer 130, and a feedback controlled blower 132, as well as a flow stabilizer (not shown) located between the inlet 120 and the nephelometer 130. The flow stabilizer is optional and can be omitted if desired. This system was built and used to collect data in a particular but non-limiting embodiment of the invention. Several other configurations are possible including the use of other aerodynamic separators, measurement devices, blowers or pumps, operational system with dual tap flow control feedback, variable blower, a flow restrictor, a cyclone separator and a nephelometer as the measurement device.

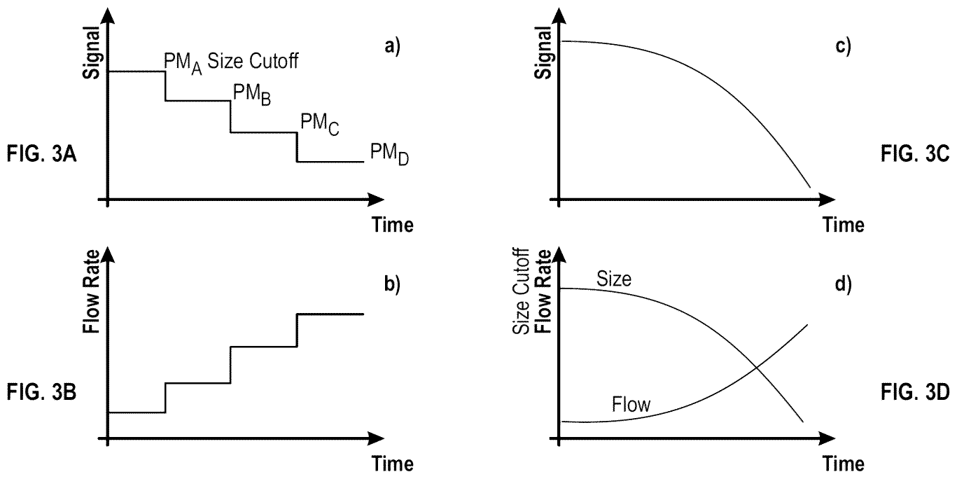

FIGS. 3A-3D show an exemplary type of data that can be collected by assembly 100. Here the data results are shown in two configurations: FIGS. 3A and 3B show the case for discrete size cutoffs where the flowrate through the aerodynamic separator 110 is varied in discrete steps, producing the same number of discrete size cutoffs. The fluid flowrate is measured in the inlet line 112 and is used to control and stabilize the blower 132 in order to produce the desired particle size cutoff. Similar flow measurements can be performed in other locations along the flow line with equivalent results, including in the outlet of assembly 100. Multiple particle size cutoffs are selected and toggled as function of time in order for the analytical instrument to measure the correspondent change in signal caused by the change in particle size. FIGS. 3C and 3D show an exemplary situation for a continuous variation in flow rate producing a continuous variation in particle cutoff size, and the corresponding change in the signal of the measurement instrument. This case also works with real time flow measurement and a feedback control system for the blower or pump 132. An alternative flow controlling system can also produce the desired effect in controlling the cutoff sizes.

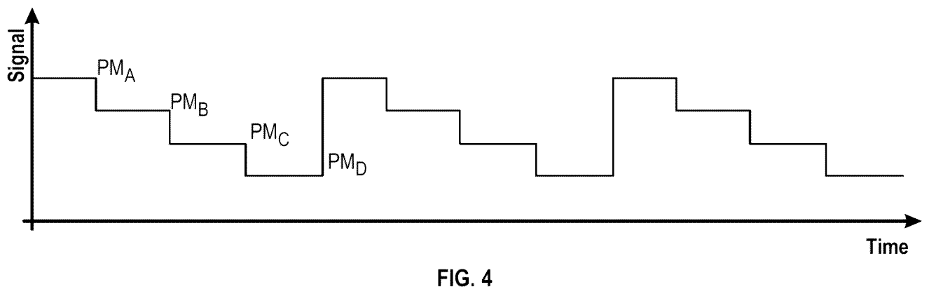

FIG. 4 shows an exemplary graph of the periodic data acquisition where the flowrate is controlled to periodically reproduce the desired particle size cutoff pattern in order to produce a long-term time series of the signal generated by the particle size variation. The example shows the case of the multiple cutoff steps, but similar technics can be applied to the continuous size selection scheme presented in FIG. 3C. A similar concept can be applied to the case of the continuum flow variation as illustrated in FIG. 3D.

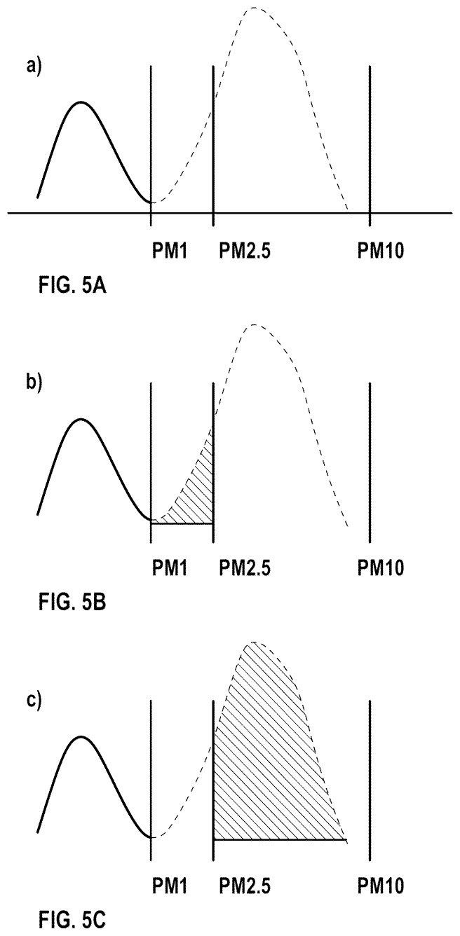

FIGS. 5A-5C are diagrams of an exemplary methodology showing how data is obtained for the software inversion. FIG. 5A shows the aerodynamic separation of the smallest size mode and how this corresponds to the part the input data set used to create the resulting size distribution obtained from the inversion of the optical data set (multiwavelength, and/or multi-angular, and/or polarization). FIG. 5B shows moving the aerodynamic cutoff to a larger size range allows for data acquisition for the inversion of the next size bin. FIG. 5C shows moving the aerodynamic cutoff to the largest PM10 cutoff size described in this example. While these ranges are shown, those skilled in the art will recognize that other range of aerodynamic sizes and cutoffs are also possible.

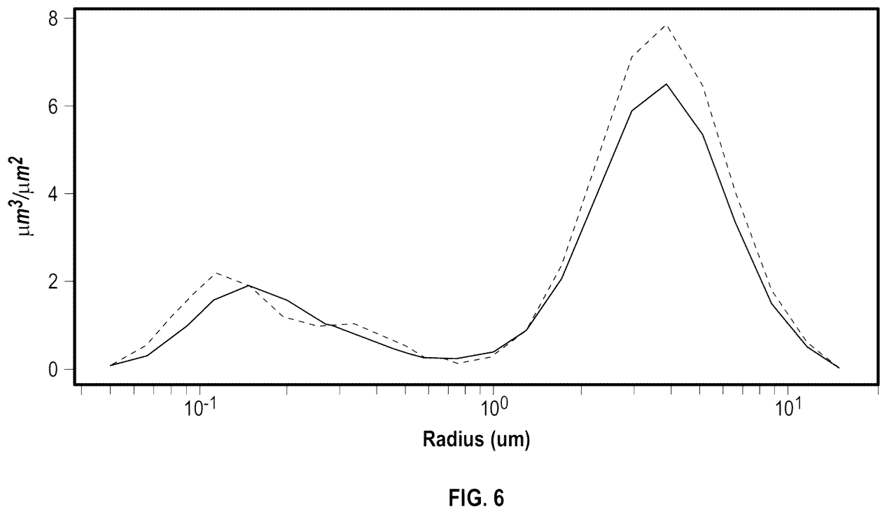

FIG. 6 is a graph showing examples of output size distributions of particles as volume per area, which is derived from the data collected by assembly 100 after the analysis performed using an exemplary numerical inversion software.

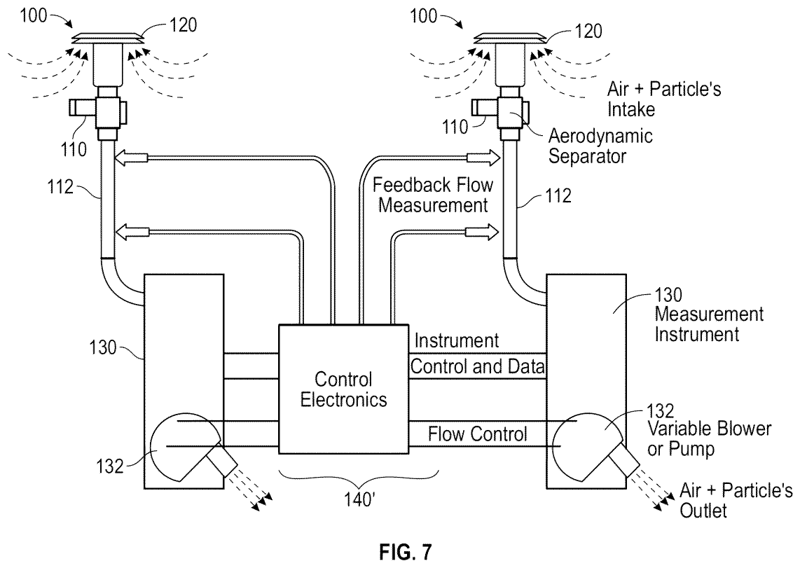

FIG. 7 shows an exemplary embodiment of the present invention with two assemblies 100 that share a common control system 140′. Separate inlet heads 120 and separate flow control systems increase the flexibility of the size measurement scheme. This embodiment has multiple modes of operations. By way of example only, a first assembly 100 can operate in a constant flowrate (or constant particle size cutoff) regime while a second assembly 100 can work with multiple flowrates corresponding to multiple cutoff sizes. The comparison between the measurements of the first and second assemblies 100 will simultaneously provide information on the variation of the particle size and particle concentration over time. Other modes of operation include the simultaneous variation of the flowrate in both inlet heads 120, or the simultaneous use of a larger number of inlet heads 120.

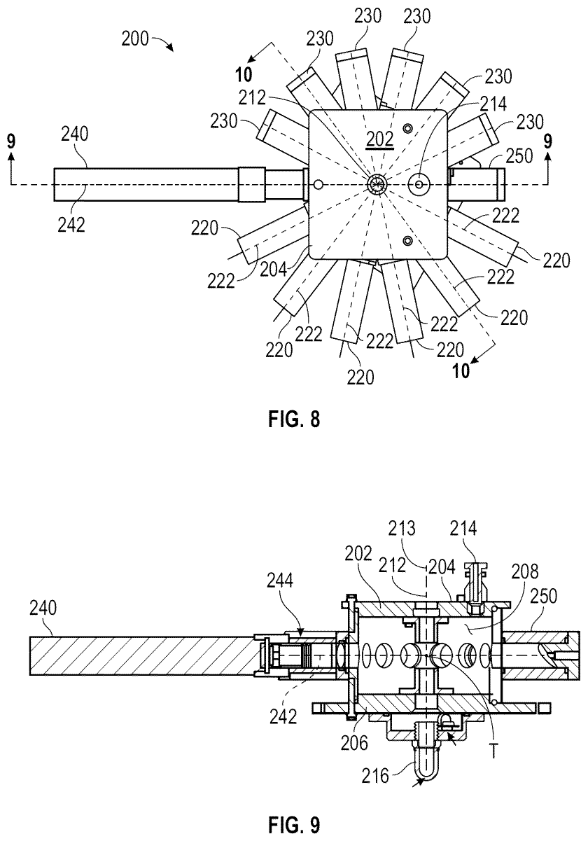

FIGS. 8-10 show an exemplary embodiment of an optical engine 200 for use as the nephelometer 100 described above. Optical engine 200 can be the measuring instrument 130 shown in FIGS. 1, 2, and 7 and includes a body 202 having a top surface 204, an opposing bottom surface 206, and a sampling chamber 208 located between the top surface 204 and the bottom surface 206.

A sampling inlet 212 is formed in the top surface 204 and extends along an inlet axis 213. Sampling inlet 212 allows ambient air surrounding optical engine 200 to enter sampling chamber 208 for sampling. To reduce restrictions of air flow into sampling chamber 208, sampling inlet 212 is a straight tube. A purge calibration inlet 214 is also provided through top surface 204. Purge calibration inlet 214 is in fluid communication with sampling chamber 208 to allow sampling chamber 208 to be filled with clean air or other gases that can be used to calibrate optical engine 200.

A sampling outlet 216 is formed in the bottom surface 206 and extends along inlet axis 213. Sampling outlet 216 allows air inside sampling chamber 208 to be sucked out to allow new air from sampling inlet 212 to take its place. Air is withdrawn through sampling outlet 206 via blower 132 (or a vacuum pump) that discharges the air out of optical engine 130.

Sampling inlet 212 is centrally located over sampling chamber 208 to allow air to flow from sampling inlet 212, into sampling chamber 208, and then out of sampling chamber 208 through outlet 216 to minimize the amount of air flow in sampling chamber 208, which could result in spurious readings.

A plurality of light sources 220 extends radially from the sampling chamber 208 such that each of the plurality of light sources 220 extends along its own longitudinal axis 222. Light sources 220 can include light emitting diodes (LEDs) 223, lasers, and incandescent light bulbs that are directed to shine light into sampling chamber 208. Also, light sources 220 can emit different wavelengths of light to capture a wide spectrum of wavelengths. In an exemplary embodiment, each light source 220 can have a range of wavelengths between about 200 nm and about 2500 nm, and, with multiple light sources 220, can cover an angular scattering range from 0 to 180°.

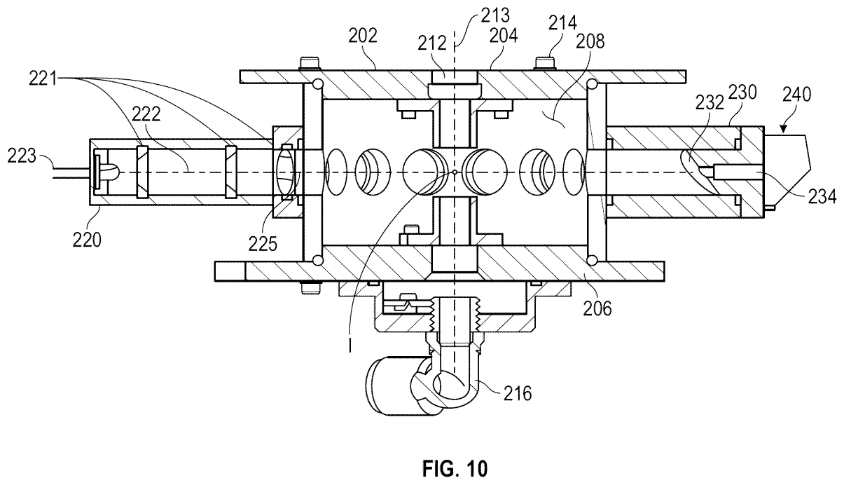

Collimators 224 and lenses 225 can be located in each light source 220, between LED 223 and sampling chamber 208. Collimators 224 are used to collimate light from light sources 220 and lenses 225 are used to keep the light focused and along axis 222. In an exemplary embodiment, as shown in FIG. 10, three collimators 224 and one lens 225 are used, although those skilled in the art will recognize that more or less than three collimators 224 and a different number of lenses 225 can be used.

A like plurality of light traps 230 as light sources 220 extends radially from the sampling chamber 208, such that each of the like plurality of light traps 230 is associated with one of the plurality of light sources 220 across the sampling chamber 208 and extends along the longitudinal axis 222 of its associated light source 220.

To further enhance the capabilities of light traps 230, each light trap 230 includes a mirror 232 extending at a 45 degree angle relative to the respective light trap's longitudinal axis 222. Each mirror 232 has a black reflective surface to absorb as much light as possible. Additionally, each light trap 230 has a darkened interior surface to further absorb as much light as possible.

Additionally, each light trap includes a reference sensor 234 located behind mirror 232. Reference sensor 234 is used to measure the amount of light that passed through sampling chamber 208 as a reference for the scattering measurement. Reference sensor 234 can also provide a measurement of the transmitted light through the measured particles.

A single optical detector 240, such as, for example, a photomultiplier tube, extends radially from the sampling chamber 208 along an optical detector longitudinal axis 242. Photomultiplier tube 240 also includes a detector telescope 244 located proximate to sampling chamber 208. Telescope 244 is used to confine the field of view of optical detector 240 within the desired scattering geometry and avoid undesired light coming from other locations within sampling chamber 208.

A photomultiplier light trap 250 is located diametrically opposite from the optical detector 240 across the sampling chamber 208 along the photomultiplier longitudinal axis 242. In an exemplary embodiment, as shown in FIG. 8, all of the plurality of light sources 220 are located on a first side of the photomultiplier longitudinal axis 242 and are located between 25 degrees and 26 degrees radially around the sampling chamber 208 from an adjacent of the plurality of light sources 220. A more general embodiment can cover angular ranges from nearly 0 up to 180 degrees and any number of light sources in between.

In an exemplary embodiment, the longitudinal axes 222, the photomultiplier longitudinal axis 242, and the inlet axis 213 all intersect inside the sampling chamber 208 at a location “I”, shown in FIGS. 9 and 10. This feature directs all optical components to a relatively small, defined area through which air flows from sampling inlet 212 to sampling outlet 216.

Referring to FIG. 8, all of light sources 220 are on a first side of photomultiplier longitudinal axis 242, while all of their respective light traps 230 are located on an opposing side of the photomultiplier longitudinal axis 242. In an alternative embodiment, however, some of the plurality of light sources 220 are located on a first side of the photomultiplier longitudinal axis 242 and a remainder of the plurality of light sources 220 are located on an opposing side of the photomultiplier longitudinal axis 242. In this alternative embodiment, light traps 230 associated with the light sources 220 on the first side of optical detector axis 242 are located on the second side of optical detector axis 242 and light traps 230 associated with the light sources 220 on the second side of optical detector axis 242 are located on the first side of optical detector axis 242.

Regardless of which side of optical detector axis 242 that light sources 220 are located, light sources 220 that are located between 0 and 90 degrees radially from the photomultiplier light trap 250 capture forward scattered light, while the light sources located between 0 and 90 degrees radially from the optical detector (photomultiplier tube) 240 capture backscattered light.

Data generated by the angularly scattered light are recorded by optical detector 240 and used to determine various parameters regarding the quality of the sampled air. By way of example only, such parameters can be the number of particles in the air, the size of the particles in the air, the shape of the particles in the air, the refractive index of the particles in the air, the color of the particles in the air. Assembly 100 takes the back scatter and forward scatter data and, through use on an inverse algorithm, takes the measured parameters and determines what particles are passing through sampling chamber 208.

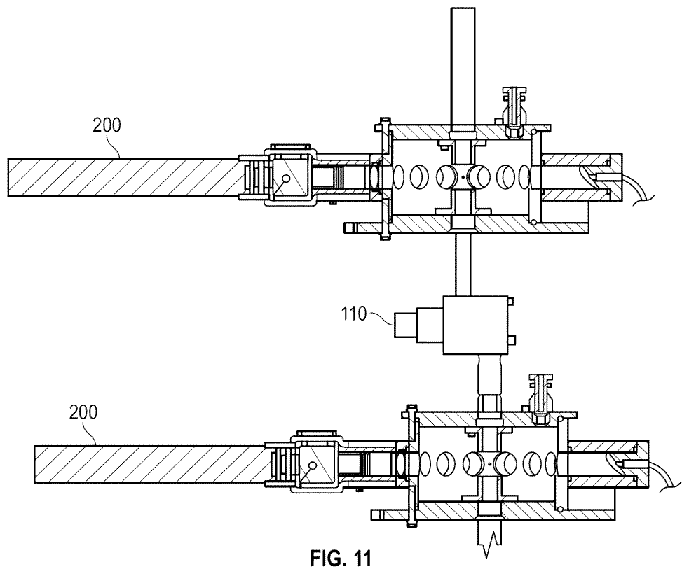

As shown in FIG. 11, multiple single optical engines 200 can be stacked on top of each other, with an aerodynamic separator 110 in between, allowing for simultaneous size selection as the air stream progresses through the stack of optical engines 100. The stackable option allows for the quasi-simultaneous measurements of other aerosol properties (extinction, absorption) with the same aerosol measured in sampling chamber 208.

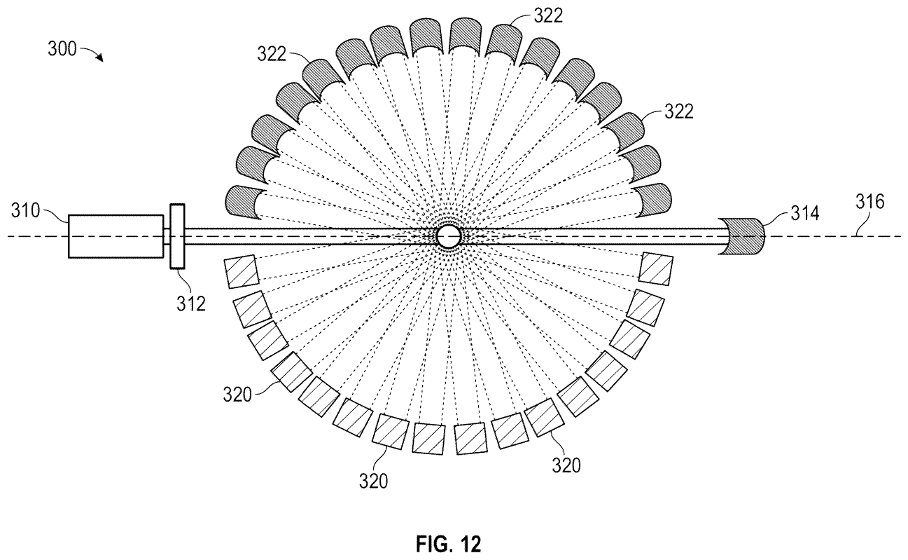

Alternative embodiments of an optical engine 300 with a multi-angle, multi-wavelength, and multi-polarization state configuration is shown in FIGS. 12-14. Optical engine 300 uses light sources of known polarization states to illuminate the particle stream, and to use a polarimeter 310 to measure the state of the light scattered by the aerosols inside sampling change 308 as function of the scattering angle.

In addition to different wavelengths, light sources can also be polarized in either static or dynamic fashions. In the static configuration, fixed polarizers are placed in front of the light source to assure that the light illuminating the particles will be in a particular state of linear or circular polarization. In the dynamic configuration, a liquid crystal retarder, a rotational polarizer, or any other time dependent polarization device is added in front of the light source to modulate the polarization state of the light incident on the particles, as function of time.

In a first configuration, shown in FIG. 12, multiple light sources 320 are distributed as function of angle, composed of individual light sources 320 with selected wavelengths, and placed at different angles with respect to sampling chamber 308 with specific polarization states. A single polarization detector 310 is provided with a light trap 314 positioned along the longitudinal axis 316 of detector 310.

In an alternative configuration, a single light source 310 and multiple polarization detectors 320 are spaced around optical engine 300. In an exemplary embodiment, light source 310 is a laser source plus a polarization modulator 312. Polarization detectors 320 are spaced around sampling chamber 308 at different angles, with particular polarization states aligned in front of each detector 320. Light traps 322 are spaced across sampling chamber 308 from each respective detector 320.

The Stokes vector (S_{scat}) of the light scattered by aerosol and cloud particles for each scattering angle can be written as function of the Stokes parameters of the Incident light Sin and the phase matrix of the particles P. For randomly oriented and assuming that time reciprocity is applicable, this relationship can be written as:

$${S}_{scat} = [ P ] [ {S}_{in} ] [ \begin{matrix}{I}_{sc} \\ {Q}_{sc} \\ {U}_{sc} \\ {V}_{sc}\end{matrix} ] = [ \begin{matrix}{P}_{11} & {P}_{12} & {P}_{13} & {P}_{14} \\ {P}_{21} & {P}_{22} & {P}_{23} & {P}_{24} \\ {P}_{31} & {P}_{32} & {P}_{33} & {P}_{34} \\ {P}_{41} & {P}_{42} & {P}_{43} & {P}_{44}\end{matrix} ] [ \begin{matrix}{I}_{in} \\ {Q}_{in} \\ {U}_{in} \\ {V}_{in}\end{matrix} ] \qquad ( 1 )$$

where I, Q, U and V are the elements of the Stokes vector.

With optical engine 300, all elements of the phase matrix, especially the six more relevant elements for aerosol scattering (P₁₁, P₁₂, P₂₂, P₃₃, P₄₄, P₃₄) can be measured. These elements can be measured with a combination of a polarization modulated light source 310 and a calibrated polarimeter as a detector.

In general, for aerosols, assuming randomly oriented particles and time reciprocity, simplifications are provided to reduce the number of independent terms in the phase matrix:

$$[ \begin{matrix}{I}_{sc} \\ {Q}_{sc} \\ {U}_{sc} \\ {V}_{sc}\end{matrix} ] = [ \begin{matrix}{P}_{11} & {P}_{12} & {P}_{13} & {P}_{14} \\ {P}_{12} & {P}_{22} & {P}_{23} & {P}_{24} \\ - {P}_{13} & - {P}_{23} & {P}_{33} & {P}_{34} \\ {P}_{14} & {P}_{24} & - {P}_{34} & {P}_{44}\end{matrix} ] [ \begin{matrix}{I}_{in} \\ {Q}_{in} \\ {U}_{in} \\ {V}_{in}\end{matrix} ] \qquad ( 2 )$$

Further simplification is also possible for the case of randomly oriented particles with equal amounts of mirrored particle geometry forcing the elements P₁₃, P₁₄, P₂₃, P₃₃, and P₂₄ to equal zero. By orienting the polarizers following the geometry of each plane, light can be produced with convenient Stokes vectors that simplify the determination of the aerosol phase matrix elements. This is not an essential condition, as the system can be calibrated and solved for any other geometry but, nevertheless, this simplified geometry is possible, and is used here to exemplify the solution.

For unpolarized incident light, the coefficients P₁₁, P₁₂, −P₁₃, P₁₄ are determined as:

$$[ \begin{matrix}{I}_{sc} \\ {Q}_{sc} \\ {U}_{sc} \\ {V}_{sc}\end{matrix} ] = [ \begin{matrix}{P}_{11} & {P}_{12} & {P}_{13} & {P}_{14} \\ {P}_{12} & {P}_{22} & {P}_{23} & {P}_{24} \\ - {P}_{13} & - {P}_{23} & {P}_{33} & {P}_{34} \\ {P}_{14} & {P}_{24} & - {P}_{34} & {P}_{44}\end{matrix} ] [ \begin{matrix}1 \\ 0 \\ 0 \\ 0\end{matrix} ] = [ \begin{matrix}{P}_{11} \\ {P}_{12} \\ - {P}_{13} \\ {P}_{14}\end{matrix} ] \qquad ( 3 )$$

With the knowledge of the previous coefficients and incident light linearly polarized in the horizontal direction at 0° the coefficients P₂₂, P₂₃, and P₂₄ are determined as:

$$[ \begin{matrix}{I}_{sc} \\ {Q}_{sc} \\ {U}_{sc} \\ {V}_{sc}\end{matrix} ] = [ \begin{matrix}{P}_{11} & {P}_{12} & {P}_{13} & {P}_{14} \\ {P}_{12} & {P}_{22} & {P}_{23} & {P}_{24} \\ - {P}_{13} & - {P}_{23} & {P}_{33} & {P}_{34} \\ {P}_{14} & {P}_{24} & - {P}_{34} & {P}_{44}\end{matrix} ] [ \begin{matrix}1 \\ 1 \\ 0 \\ 0\end{matrix} ] = [ \begin{matrix}{P}_{11} + {P}_{12} \\ {P}_{12} + {P}_{22} \\ - {P}_{13} - {P}_{23} \\ {P}_{14} + {P}_{24}\end{matrix} ] \qquad ( 4 )$$

Incident light linearly polarized at 45°.

$$[ \begin{matrix}{I}_{sc} \\ {Q}_{sc} \\ {U}_{sc} \\ {V}_{sc}\end{matrix} ] = [ \begin{matrix}{P}_{11} & {P}_{12} & {P}_{13} & {P}_{14} \\ {P}_{12} & {P}_{22} & {P}_{23} & {P}_{24} \\ - {P}_{13} & - {P}_{23} & {P}_{33} & {P}_{34} \\ {P}_{14} & {P}_{24} & - {P}_{34} & {P}_{44}\end{matrix} ] [ \begin{matrix}1 \\ 0 \\ 1 \\ 0\end{matrix} ] = [ \begin{matrix}{P}_{11} + {P}_{13} \\ {P}_{12} + {P}_{23} \\ - {P}_{13} + {P}_{33} \\ {P}_{14} - {P}_{34}\end{matrix} ] \qquad ( 5 )$$

Incident light circularly polarized.

$$[ \begin{matrix}{I}_{sc} \\ {Q}_{sc} \\ {U}_{sc} \\ {V}_{sc}\end{matrix} ] = [ \begin{matrix}{P}_{11} & {P}_{12} & {P}_{13} & {P}_{14} \\ {P}_{12} & {P}_{22} & {P}_{23} & {P}_{24} \\ - {P}_{13} & - {P}_{23} & {P}_{33} & {P}_{34} \\ {P}_{14} & {P}_{24} & - {P}_{34} & {P}_{44}\end{matrix} ] [ \begin{matrix}1 \\ 0 \\ 0 \\ 1\end{matrix} ] = [ \begin{matrix}{P}_{11} + {P}_{14} \\ {P}_{12} + {P}_{24} \\ - {P}_{13} + {P}_{34} \\ {P}_{14} + {P}_{44}\end{matrix} ] \qquad ( 6 )$$

The four conditions above are enough to solve all elements of the phase matrix but, other geometries are also possible and may be more convenient in some situations. For example, for a laser source, instead of the unpolarized situation in Eq. 3, it may be more convenient to use the case of linearly polarized light in the direction perpendicular to the scattering plane (90°) providing:

$$[ \begin{matrix}{I}_{sc} \\ {Q}_{sc} \\ {U}_{sc} \\ {V}_{sc}\end{matrix} ] = [ \begin{matrix}{P}_{11} & {P}_{12} & {P}_{13} & {P}_{14} \\ {P}_{12} & {P}_{22} & {P}_{23} & {P}_{24} \\ - {P}_{13} & - {P}_{23} & {P}_{33} & {P}_{34} \\ {P}_{14} & {P}_{24} & - {P}_{34} & {P}_{44}\end{matrix} ] [ \begin{matrix}1 \\ - 1 \\ 0 \\ 0\end{matrix} ] = [ \begin{matrix}{P}_{11} - {P}_{12} \\ {P}_{12} - {P}_{22} \\ - {P}_{13} + {P}_{23} \\ {P}_{14} - {P}_{24}\end{matrix} ] \qquad ( 7 )$$

These simplified geometries where the sources are aligned with the plane of incidence are possible in all proposed configurations of our system but, they are not essential. The system can also be solved in situations where the source is not aligned with the scattering plane.

The calibration of the polarimetric detector will follow the calibration procedure developed by Fernandez-Borda at al., for a generic polarimeter. The calibration procedure was developed based on the intensity measurement of three detectors following linear polarizers oriented at three independent angles. Optical engine 300 adds a fourth detector furnished with a circular polarizer (quarter waveplate+linear polarizer at) 45°. Equation 8 shows the Intensity measured by the four detectors, where each line of the [M] matrix corresponds to the first row of a scattering matrix for the optical system including all elements between the light source and the intensity detector.

$$\begin{matrix}Detector 1 \\ Detector 2 \\ Detector 3 \\ Detector 4\end{matrix} [ \begin{matrix}{I}_{1} \\ {I}_{2} \\ {I}_{3} \\ {I}_{4}\end{matrix} ] = [ \begin{matrix}{A}_{11} & {A}_{12} & {A}_{13} & {A}_{14} \\ {B}_{11} & {B}_{12} & {B}_{13} & {B}_{14} \\ {C}_{11} & {C}_{12} & {C}_{13} & {C}_{14} \\ {D}_{11} & {D}_{12} & {D}_{13} & {D}_{14}\end{matrix} ] [ \begin{matrix}{I}_{in} \\ {Q}_{in} \\ {U}_{in} \\ {V}_{in}\end{matrix} ] = [ M ] [ \begin{matrix}{I}_{in} \\ {Q}_{in} \\ {U}_{in} \\ {V}_{in}\end{matrix} ] \qquad ( 8 )$$

[M] is the system's calibration matrix. Each element of [M] calculated can be determined by using gases and particles with known scattering properties like polystyrene spheres of different sizes, water droplets, salt particles, CO₂ and N₂ gases. A minimum of 4 independent scatterers are required for the determination of all elements of the calibration matrix. After the [M] elements are determined, we can use the inverse matrix [M]⁻¹ to calculate the Stokes vector of the scattered light based on the measured intensities I₁, I₂, I₃, and I₄ as:

$$[ \begin{matrix}{I}_{scat} \\ {Q}_{scat} \\ {U}_{scat} \\ {V}_{scat}\end{matrix} ] = {[ M ]}^{- 1} [ \begin{matrix}{I}_{1} \\ {I}_{2} \\ {I}_{3} \\ {I}_{4}\end{matrix} ] \qquad ( 9 )$$

The theoretical description above shows that the aerosol phase matrix elements can be obtained by combining the modulation of the light source into different polarization conditions and measuring the polarization state of the scattered light. These measurements are to be performed as function of scattering angle and wavelength.

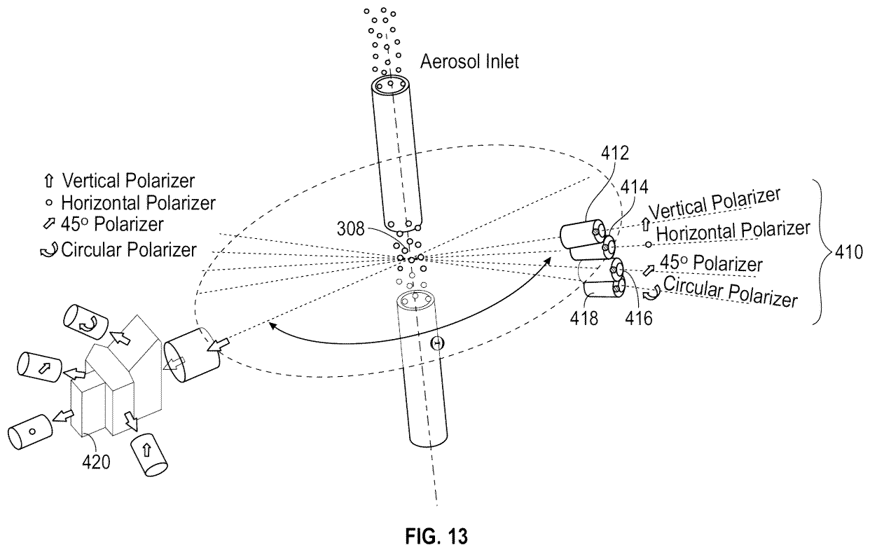

FIG. 13 shows a schematic description of how the generic design proposed in FIG. 12 can be implemented into the multi-source configuration proposed above. In this configuration, a main light source 410 includes four separate light sources, namely, a vertically polarized source 412, a horizontally polarized source 414, a 45° polarized source 416, and a circularly polarized source 418. The light sources 412-418 are activated sequentially, producing linearly polarized light in particular angles, as well as circularly polarized light, as a function of wavelengths. Each source 412, 416 illuminates the aerosol particles flowing at the center of the sampling chamber 308. The scattered light is measured by a full polarimeter 420 following similar concept of the HARP polarimeter with ports 422, 424, 426, 428 for the measurement of vertical polarization, horizontal polarization, 45° polarization, and circular polarization, respectively.

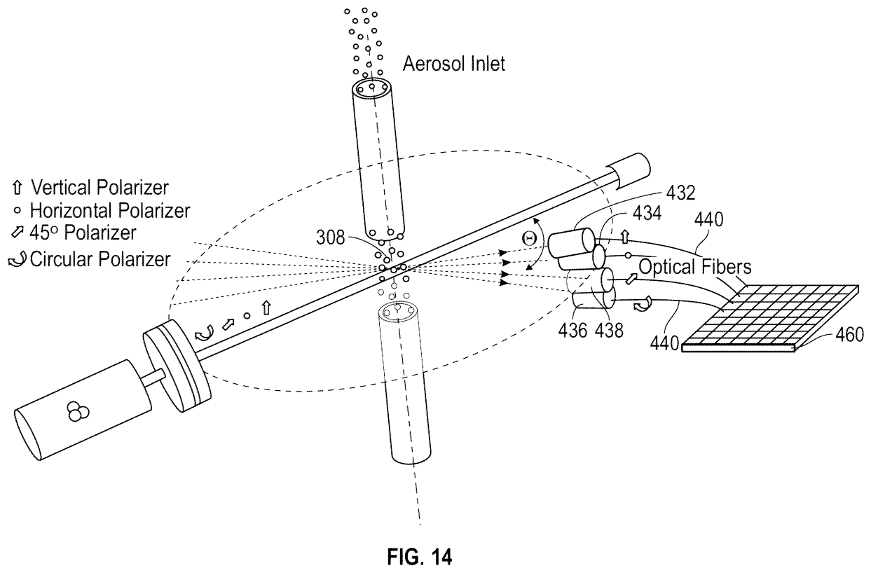

The recent advent of Solid State Silicon Photomultipliers (SiPM) makes a multi-detector configuration as described above a viable commercial option. The main advantages of the SiPM are their high sensitivity, down to single photons, low cost, fast speed, and their availability in multi-element detector arrays allowing for the easy use of large number of detectors. FIG. 14 shows a schematic representation of the multi-detector alternative using an 8×8 SiPM array 460, and a detection system consisting of telescope connectors 432, 434, 436, 438 and a fiber optic bundle 440 projecting the collected light into each pixel of the SiPM array. Each set of the four detectors 432, 434, 436, 438 is furnished with a particular polarizer (e.g. vertical, horizontal, 45°, and circular) that are measured independently.

The unique angular scattering pattern produced by the optical engine geometry in a combination with multiple wavelengths and polarization states will be used to fit pre-calculated scattering functions. The result of these fittings will allow the users to determine the type, size, morphology, and refractive indices of the particles (or collection of particles) within the sampling chamber, which will be referred herein as an optical inversion or retrieval. This inversion can be used in combination with the aerodynamic separation method described above, which allows the user to determine the density of the particles, as well as their mass concentration. These determinations are possible because of the combination of the aerodynamic size separation (which is related to the density of particles) and the optical sizing of the particles, which is related to their geometrical size.

A method for the determination of the aerosol mass density and particle mass using the optical engines described above is now provided. This method relies on the difference between the aerodynamic and geometrical diameter of a particle. For simplicity of the description, it is assumed that the particle is spherical but, this is not a limitation of the technique, which can be applied to any particle shape. Measurements from the optical engines described above can be used for the full retrieval of the particle size distribution and other optical properties like the refractive index of the material. This distribution will be assumed as the geometrical diameter (or size) of the particles described here as d_{g}. The relationship between the aerodynamic (dₐ) and the geometric diameter (d_{g}) of a sphere (particle) is related to the material density by the following expression:

$${d}_{a} = {d}_{g} \cdot \sqrt{{ρ}_{p}} \qquad ( 10 )$$

where ρₚ is the density of the particle material.

Given the particle size distribution for spheres and the material refractive index (both of which can be retrieved based on measurements of the optical engines described above), one can calculate the scattering properties of the particles as function of the particle geometrical size. For instance the scattering intensity can be calculated at the same angles that are measured by the optical engine. These calculated values can be directly compared with the measured values at different aerodynamic sizes. For a given aerodynamic size, the geometrical cutoff diameter used in the optical calculation can be varied until the calculated scattering intensity agrees with the measured scattering intensity. At that point, the geometrical diameter in the optical size distribution can be determined, which corresponds to the aerodynamic cut off size, selected by the instrument flow rate. An illustration of the aerodynamic and geometrical diameters for a given size distribution is illustrated in FIG. 5.

Since method provides a measurement of the geometric diameter (d_{g}) that corresponds to the pre-determined aerodynamic diameter (dₐ) set by the instrument flowrate, the particle density can be calculated as:

$${ρ}_{p} = {( \frac{{d}_{a}}{{d}_{g}} )}^{2} \qquad ( 11 )$$

The size distribution of the particles as well as its mass density are now determined. With these two parameters at hand, it is now possible to also determine the aerosol mass or, more precisely, the aerosol mass concentration for the measured collection of particles.

This method was described in simplified fashion in this text but, similar results can be obtained simultaneously as part of a full inversion technique that will simultaneously constrain and minimize the differences the measured versus modelled parameters, in order to determine an optimum solution to the system.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. An optical engine comprising:
a body having a top surface, an opposing bottom surface, a central longitudinal axis, and a sampling chamber located between the top surface and the bottom surface;
a plurality of light sources all on a first side of the central longitudinal axis and none on a second side of the central longitudinal axis, the plurality of light sources extending radially from the sampling chamber such that each of the plurality of light sources extends along its own longitudinal axis;
a like plurality of light traps extending radially from the sampling chamber, all on the second side of the second longitudinal axis and none on the first side of the central longitudinal axis, each of the like plurality of light traps being associated with one of the plurality of light sources across the sampling chamber and extending diametrically across the sampling chamber along the longitudinal axis of its associated light source;
an optical detector extending radially from the sampling chamber along the central longitudinal axis, different from the longitudinal axes of the light sources and the light traps; and
a photomultiplier light trap diametrically opposite from the optical detector across the sampling chamber along the central longitudinal axis.

2. The optical engine according to claim 1, further comprising a sampling inlet formed in the top surface.

3. The optical engine according to claim 1, further comprising a sampling outlet formed in the bottom surface.

4. The optical engine according to claim 1, wherein a first of the plurality of light sources generates light at a different wavelength than a second of the plurality of light sources.

5. The optical engine according to claim 1, wherein each light source comprises a light emitting diode.

6. The optical engine according to claim 5, further comprising at least one collimator located in each light source between the light emitting diode and the sampling chamber.

7. The optical engine according to claim 1, wherein each light trap comprises a mirror extending at a 45 degree angle relative to the respective light trap's longitudinal axis.

8. The optical engine according to claim 7, wherein each mirror has a black reflective surface.

9. The optical engine according to claim 7, wherein each light trap comprises a darkened interior surface.

10. The optical engine according to claim 1, wherein the photomultiplier light trap comprises a reference sensor.

11. The optical engine according to claim 1 wherein a first of the plurality of light sources is located between 25 degrees and 26 degrees radially around the sampling chamber from an adjacent of the plurality of light sources.

12. The optical engine according to claim 1, wherein one of the light sources located between 0 and 90 degrees radially from the photomultiplier light trap captures forward scatter.

13. The optical engine according to claim 12, wherein another of the light sources located between 0 and 90 degrees radially from the optical detector captures back scatter.

14. An optical engine comprising:
a sampling chamber;
a plurality of light sources extending radially from the sampling chamber such that each of the plurality of light sources extends along its own longitudinal axis;
a like plurality of light traps extending radially from the sampling chamber, each of the like plurality of light traps being associated with
one of the plurality of light sources across the sampling chamber and extending along the longitudinal axis of its associated light source;
an optical detector extending radially from the sampling chamber along a photomultiplier longitudinal axis, different from the longitudinal axes of the light sources and the light traps; and
a photomultiplier light trap diametrically opposite from the optical detector across the sampling chamber along the photomultiplier longitudinal axis,
wherein all of the plurality of light sources are located on a first side of the photomultiplier longitudinal axis and none of the plurality of light sources are located on a second side of the photomultiplier axis, and all of the like plurality of light traps are located on the second side of the photomultiplier longitudinal axis, distal from the first side of the photomultiplier longitudinal axis, and none of the plurality of light traps are located on the first side of the photomultiplier longitudinal axis.

15. The optical engine according to claim 14, further comprising a sampling inlet extending along an inlet axis and a sampling outlet extending along the inlet axis, such that the inlet axis extends across the sampling chamber.

16. The optical engine according to claim 15, wherein the longitudinal axis, the photomultiplier longitudinal axis, and the inlet axis all intersect inside the sampling chamber.

17. The optical engine according to claim 14, further comprising a purge calibration inlet in fluid communication with the sampling chamber.

18. The optical engine according to claim 14, wherein each light trap comprises a reference sensor.
